(19) United States
(12) Patent Application Publication
(10) Pub. No.: US 2010/0270952 A1
(43) Pub. Date: Oct. 28, 2010

(54) Method for Lighting HID Lamps Instantly after Switching on and HID Lamps Using the Method

(75) Inventor: XIAOHUA LU, Huzhou (CN)

Correspondence Address: GLOBAL IP SERVICES, 7285 W. Eagle Court, Winton, CA, 95388, US

(73) Assignee: HUZHOU HUASHI LIGHTING CO., LTD., Huzhou (CN)

(21) Appl. No.: 12/541,365

(22) Filed: Aug. 14, 2009

(30) Foreign Application Priority Data
Apr. 24, 2009 (CN) 200910135668.6

(51) Int. Cl. H05B 41/04

(52) U.S. Cl. 315/313

(57) ABSTRACT

This invention discloses a method for HID lamp to be lighted instantly when power is on and the related HID lamp. The method is to connect two luminous bodies in parallel and then link it with the power supply through a ballast. When the power is turned on, only one HID luminous body is lighted up; when power is turned off and turned on again, the other HID luminous body is triggered to light up. The HID lamp that can light instantly when power on includes a lamp cap, lamp shape and a ballast that connects the power supply and the lamp cap. There are at least two HID luminous bodies, each of which is connected in parallel. Two lead wires are connected with the lamp cap respectively. In this invention, at least two HID luminous bodies are connected in parallel. When HID light is turned on, only one HID luminous body is lighted up. When it is turned on again, other HID luminous bodies that are connected in parallel are triggered to light up. There is no need to wait for HID luminous bodies to cool down so that HID lamp can be lighted up as the power is turned on. It is very convenient to use.

### CROSS REFERENCE TO THE RELATED PATENT APPLICATION

The present application claims the priority of the Chinese patent application No. 200910135668.6 filed on Apr. 24, 2009, which application is incorporated herein by reference.

### FILED OF THE INVENTION

This invention is relating to the technical area of luminaries, especially the technical area of HID lamp.

### BACKGROUND OF THE INVENTION

HID (High-Intensity Discharge) has been accepted increasingly by the people and widely applied in commerce and indoor illumination as it has good colors, sound luminous effect, rich hues and long life span. However, HID lamps have poor performance in hot starting. When the temperature is high, it needs three to five minutes to be lighted again. This causes a lot of inconvenience to the users and restrained popular application to HID lamps.

### SUMMARY OF THE INVENTION

This invention aims to solve the defects in existing technologies and provide a method for lighting HID lamps instantly after switching on and HID lamps using the method, which can allow HID lamp to be lighted up as the power is on. It is more convenient to use.

To realize the above aim, the solution to instant lighting the HID lamps after switching on, in this invention is:

Connecting at least two HID luminous bodies in parallel, then connecting the at least two luminous bodies in parallel with a power supply through a ballast, when switching on, one luminous body is lighted only, when switching off and switching on again, other HID luminous body in parallel is lighted instantly.

A HID lamp that can be instantly lighted upon power on includes:

a lamp cap having two joints;

a lampshade;

a ballast connecting a power supply with the one joint of the lamp cap;

at least two HID luminous bodies inside of the lampshade being connected in parallel with two ends which are connected with the two joints of the lamp cap respectively.

The mentioned ballast is traditional ballast or electric ballast.

The mentioned power supply is alternating current mains or direct current mains.

The said HID luminous body is mercury lamp luminous body, sodium luminous body, metal halide lamp luminous body or ceramic metal halide lamp luminous body.

There are the fluorescent powders on the inner wall of the mentioned lampshade.

This invention is beneficial in that it has two HID luminous bodies connected in parallel. When the HID lamp is turned on, only one HID luminous body is lighting up. When it is turned on again, other HID luminous bodies in parallel are triggered to light up. There is no need to wait for HID luminous body to cool down so that HID luminous body can be lightened up instantly as the power is on. It is very convenient to use.

### BRIEF DESCRIPTION OF THE DRAWINGS

FIG. 1 is the structure diagram showing the HID lamp of the present invention.

FIG. 2 is the circuit diagram for the present invention.

### DETAILED DESCRIPTION OF THE INVENTION

The method in this invention is to connect two luminous bodies in parallel and then connect with the power supply through ballast. When the lamp is turned on, only one HID luminous body is lightened. When it is turned on again, the other HID luminous body in parallel is triggered to light.

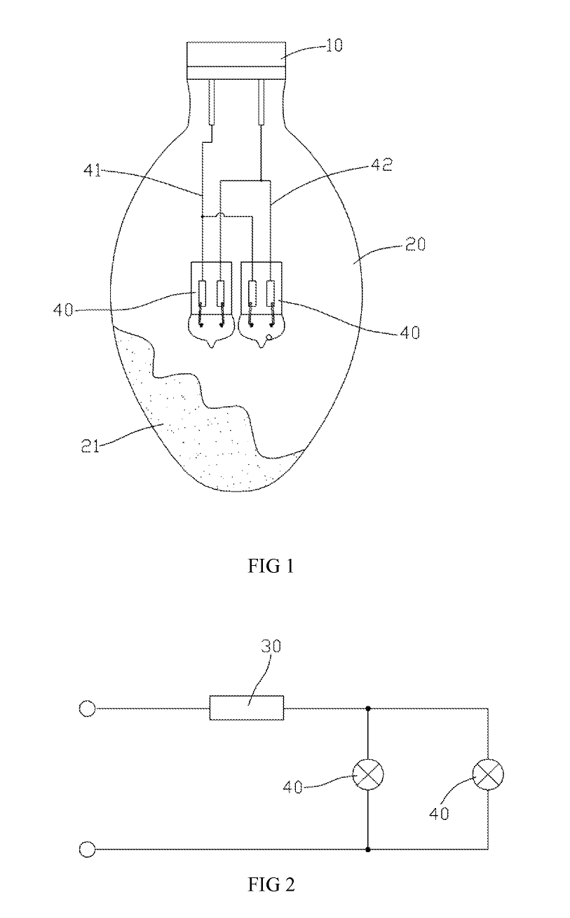

As shown in the FIG. 1 and FIG. 2, the HID lamp which can be lighted instantly when turned on includes a lamp cap 10, a lampshade 20, and a ballast 30, two ends of the ballast 30 connect the power supply and the lamp cap respectively. There are fluorescent powders 21 on the inner wall of lampshade 20. Inside the lampshade there are two (three or more) luminous bodies 40. Two HID luminous bodies 40 are connected in parallel. Its two lead wires 41, 42 are connected with lamp cap 10 respectively.

What needs to be specified is that there can also be no fluorescent powders 21 on the inner wall of lampshade 20. Ballast 30 can be traditional ballast or the electric ballast. The power supply can be alternating current or direct current. HID luminous bodies are any one of the mercury lamp luminous body, sodium luminous body, metal halide lamp luminous body or ceramic metal halide lamp luminous body. Its structure and operating principles are familiar to the technicians in this field, which are repeated no more here. The luminous bodies 40 connected in parallel can be the same type and model or different types and models.

When HID lamp is turned on, only one HID luminous body 40 is lightened up and the other HID luminous body is not lighted up. When HID lamp is turned off and turned on again, the other HID luminous body 40 is triggered to light up so that HID lamp can be lighting up as soon as the power is turned on.

Although the present invention and its advantages have been described in detail, it should be understood that the present invention is not limited to or defined by what is shown or described herein. As one of ordinary skill in the art will appreciate, various changes, substitutions, and alterations could be made or otherwise implemented without departing from the principles of the present invention.

What is claimed is:

1. A method for lighting HID lamps instantly after switching on comprising:
connecting at least two HID luminous bodies in parallel, then connecting the at least two luminous bodies in parallel with a power supply through a ballast, when switching on, one luminous body is lighted only, when switching off and switching on again, other HID luminous body in parallel is light instantly.

2. The method of claim 1, wherein said ballast is a traditional or electronic ballast.

3. The method of claim 1, wherein said power supply is an alternating current supply or a direct current supply.

4. The method of claims 1, wherein said HID luminous bodies are mercury lamps, sodium lamps, metal halide lamps or ceramic metal halide lamps.

5. An HID lamp using the method of claim 1 comprising:
a lamp cap having two joints;
a lampshade;
a ballast connecting a power supply with the one joint of the lamp cap;
at least two HID luminous bodies inside of the lampshade being connected in parallel with two ends which are connected with the two joints of the lamp cap respectively.

6. The HID lamp of claim 5, wherein said ballast is a traditional or electronic ballast.

7. The HID lamp of claim 5, wherein said power supply is an alternating current supply or direct current supply.

8. The HID lamp of claims 5, wherein said HID luminous bodies are mercury lamps, sodium lamps, metal halide lamps or ceramic metal halide lamps.

9. The HID lamp of claim 8, wherein there are fluorescent powders on an inner wall of the lampshade.
